(19) United States
(12) Patent Application Publication
(10) Pub. No.: US 2024/0342545 A1
(43) Pub. Date: Oct. 17, 2024

(54) EXERCISE MACHINES AND METHODS FOR CONTROLLING EXERCISE MACHINES

(71) Applicant: Life Fitness, LLC, Franklin Park, IL (US)

(72) Inventors: Ferdinand P. David, Hainesville, IL (US); Byron T. DeKnock, Des Plaines, IL (US); Tracy Barrett, Tulsa, OK (US); Kyle Spoo, Sycamore, IL (US); Matt Brennand, Franklin Park, IL (US)

(73) Assignee: Life Fitness, LLC, Franklin Park, IL (US)

(21) Appl. No.: 18/443,897

(22) Filed: Feb. 16, 2024

Related U.S. Application Data
(60) Provisional application No. 63/447,535, filed on Feb. 22, 2023.

(51) Int. Cl. A63B 21/00; A63B 22/06

(52) U.S. Cl. CPC A63B 21/4033; A63B 22/0605; A61H 2201/1633; A61H 2201/1664

(57) ABSTRACT

An exercise machine configured for a user to perform an exercise motion. A first frame is configured to be positioned on a floor. A second frame is supported by the first frame, the second frame being manually moveable by the user relative to the first frame into a desired position for the user to perform the exercise motion. A sensor detects an actual position of the second frame relative to the first frame. A display device is configured to display the actual position detected by the sensor to assist the user in moving the second frame into the desired position.

### CROSS REFERENCED APPLICATIONS

This application claims the benefit of U.S. Provisional Patent Application No. 63/447,535, filed Feb. 22, 2023, which is incorporated herein by reference in its entirety.

### FIELD

The present disclosure generally relates to exercise machines and methods for controlling exercise machines, and particularly to exercise machines in which one frame is moveable relative to another frame into a desired position for a user to perform an exercise motion.

### BACKGROUND

The following U.S. Patents provide background information and are incorporated by reference in their entireties.

U.S. Pat. No. 10,843,038 discloses an exercise machine having a first frame member, a second frame member that is movable with respect to the first frame member, and a locking device having at least one cam that is rotatable into and between a locked position in which the cam abuttingly engages and thereby retains the second frame member in position with respect to the first frame member and an unlocked position in which the cam is spaced from and thereby frees the second frame member for movement with respect to the first frame member.

U.S. Pat. No. 10,071,286 discloses systems and methods for determining and indicating a desired corrective change in exercise technique to an operator and optionally for determining and indicating a correct or incorrect fit between an operator and an exercise equipment. The systems comprise an exercise apparatus that is engaged by an operator at least a first contact location; a first load sensor device that senses an operator-applied load amount at the first contact location; a controller that determines a desired corrective change in exercise technique and/or the correct or incorrect fit between the operator and the exercise equipment based at least upon the operator-applied load amount at the first contact location and a current body weight of the operator; and an indicator device that indicates the desired corrective change in exercise technique and/or correct or incorrect fit, for example to an operator or an instructor.

U.S. Pat. Nos. 8,496,297 and 7,874,615 disclose exercise bicycles and several mechanisms for permitting a user to adjust the seat on an exercise bicycle. The described mechanisms can be used to adjust the height of the seat or the fore and aft positioning of the seat on an upright type bicycle. Each of the described mechanisms can be configured to provide users with an optimum seat position and with a convenient latch mechanism to adjust the position of the seat.

U.S. Pat. No. 7,713,176 discloses a recumbent step exercise machine including a frame, a seat supported from the frame, and a drive mechanism supported from the frame. The drive mechanism includes a first and a second pedal, at least one axle shaft, at least one clutch, a speed increaser, and a brake.

U.S. Pat. No. 7,267,635 discloses a stationary exercise bicycle having a frame, a resistance member, a drive assembly, a right pedal, a left pedal, a seat and an adjustable seat mechanism utilizing a rack. Assembly and disassembly of a three piece crank arm assembly is accomplished without requiring the assembling and disassembling of the entire drive assembly. The stationary exercise bicycle also provides a variety of users with an optimum seat position and with a convenient latch mechanism to adjust the position of the seat.

Additional U.S. Patents are relevant for disclosing additional types of exercise machines and control thereof. In particular, U.S. Pat. Nos. 9,238,158 and 9,216,317 disclose stair climbing type exercise machines. U.S. Pat. Nos. 6,572,512; 6,095,951; 4,749,181; 4,664,371; 4,659,074; 4,643,418; 4,635,928; 4,635,927; 4,614,337; and 4,334,676; and, as well as U.S. Patent Pub. No. 2021/0283465 and U.S. patent application Ser. No. 17/946,295, disclose treadmill type exercise machines.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure generally relates to an exercise machine configured for a user to perform an exercise motion. A first frame is configured to be positioned on a floor. A second frame is supported by the first frame, the second frame being manually moveable by the user relative to the first frame into a desired position for the user to perform the exercise motion. A sensor detects an actual position of the second frame relative to the first frame. A display device displays the actual position detected by the sensor to assist the user in moving the second frame into the desired position.

In certain examples, the second frame may support a seat upon which the user sits to perform the exercise motion such that the seat is moveable relative to the first frame.

In certain examples, the second frame may slide relative to the first frame.

In certain examples, the sensor may include a circuit board and a magnet that is moveable relative to the circuit board, wherein the circuit board detects a position of the magnet relative thereto, wherein moving the second frame relative to the first frame changes the position of the magnet relative to the circuit board, and wherein the position of the second frame relative to the first frame is detected based on the position of the magnet relative to the circuit board. In further aspects, the circuit board is stationary relative to the first frame, and wherein the magnet moves with the second frame. In certain examples, a casing is provided that at least partially covers one of the first frame and the second frame, wherein the casing has an outer surface with a channel extending inwardly therefrom, and wherein the circuit board is positioned in the channel so as to be at least partially protected below the outer surface of the casing. In certain examples, a cover is provided that encloses the circuit board within the channel to protect the circuit board therein. In further aspects, the cover is a decal with markings for visually indicating the actual position of the second frame relative to the first frame separately from the sensor.

In certain examples, a control system may be provided, the control system having a memory system for storing the actual position of the second frame detected by the sensor as a stored position, wherein the display device is configured to display the stored position to assist the user in moving the second frame into the desired position. In certain examples, a second sensor is provided and configured to detect a speed at which the exercise motion is performed, wherein the control system is configured to automatically store the actual position of the second frame as the stored position only when the speed of the exercise motion exceeds a minimum threshold. In certain examples, the display device is configured to display an indication when the actual position detected by the sensor is different than the stored position. In further aspects, the display device is configured to display the stored position and the actual position detected by the sensor at the same time.

In certain examples, the sensor may be a first sensor, further comprising a third frame supported by the first frame, wherein the third frame is manually moveable by the user relative to the first frame into a desired position for the user to perform the exercise motion, and wherein the third frame is moveable independently from the second frame, further comprising a second sensor that detects an actual position of the third frame relative to the first frame, wherein the display device displays the actual position of the third frame detected by the second sensor to assist the user in moving the third frame into the desired position thereof. In further aspects, the second frame supports handlebars configured to be gripped by the user and the third frame supports a seat configured for the user to sit thereon to perform the exercise motion.

In certain examples, the exercise motion is performed by the user pedaling.

Another aspect generally relates to a method for controlling an exercise machine. The exercise machine includes a first frame configured to be positioned on a floor and a second frame supported by the first frame and manually moveable by a user relative to the first frame into a desired position for the user to perform an exercise motion. The method includes detecting with a sensor an actual position of the second frame relative to the first frame. The method further includes displaying with a display device the actual position detected by the sensor to assist the user in moving the second frame into the desired position.

In certain examples the method further includes retrieving a stored position of the second frame relative to the first frame and displaying the stored position on the display device to assist the user in moving the second frame to the stored position as the desired position.

In certain examples the method further includes retrieving a stored position of the second frame relative to the first frame, comparing the actual position detected by the sensor to the stored position, and indicating when the stored position and the actual position vary by at least a threshold difference.

In certain examples the method further includes detecting a speed at which the exercise motion is performed, comparing the speed to a minimum threshold, and automatically storing the actual position of the second frame as a stored position when the speed of the exercise motion exceeds the minimum threshold.

In certain examples the method further includes receiving height information for the user, determining a recommended position for the second frame relative to the first frame based on the height information, comparing the actual position detected by the sensor to the recommended position, and indicating when the recommended position and the actual position vary by at least a threshold difference.

It should be recognized that the different aspects described throughout this disclosure may be combined in different manners, including those than expressly disclosed in the provided examples, while still constituting an invention accord to the present disclosure.

Various other features, objects and advantages of the disclosure will be made apparent from the following description taken together with the drawings.

### BRIEF DESCRIPTION OF THE DRAWINGS

FIG. 1 is a right side view of a first exercise machine according to the present disclosure with a cover removed.

FIG. 2 is a partial cross-sectional left side view of the exercise machine of FIG. 1 depicting a seat that is manually moveable relative to a base frame.

FIG. 3 is a left perspective view of a second exercise machine according to the present disclosure.

FIG. 4 is a partial close-up left view of a lower portion of the exercise machine of FIG. 3 depicting a seat that is manually moveable relative to a base frame.

FIG. 5 is a right perspective view of an upper portion of a third exercise machine according to the present disclosure, depicting handlebars that are manually moveable relative to a base frame and depicting a sensor according to the present disclosure.

FIG. 6 is a front perspective view of the upper portion of the exercise machine of FIG. 5.

FIG. 7 is an exploded left perspective view of a lower portion of the exercise machine of FIG. 1 depicting a sensor according to the present disclosure.

FIG. 8 is a left perspective sectional view of a lower portion of the exercise machine of FIG. 3 depicting a sensor according to the present disclosure.

FIG. 9 is a sectional view taken along the line A-A of the exercise machine shown in FIG. 8.

FIG. 10 is a schematic view of an example of a control system for operating an exercise machine according to the present disclosure.

FIG. 11 depicts a first display displaying actual positions and stored positions of a seat and handlebars according to the present disclosure.

FIG. 12 depicts a second display displaying an actual position and a stored position of a seat according to the present disclosure.

FIG. 13 depicts a third display displaying actual positions and recommended positions of a seat according to the present disclosure.

FIG. 14 depicts a first example of a method for controlling an exercise machine according to the present disclosure.

FIG. 15 depicts a second example of a method for controlling an exercise machine according to the present disclosure.

FIG. 16 depicts a third example of a method for controlling an exercise machine according to the present disclosure.

FIG. 17 depicts a display displaying recommendations for seat positions by height.

FIG. 18 depicts another display displaying recommendations for seat positions by height, as well as previously stored seat and handlebar positions.

FIG. 19 depicts another display displaying recommendations for seat positions by height, and also indicating that an actual seat position is within the recommended range.

FIG. 20 depicts an example of a method for providing recommended seat and/or handlebar positions according to the present disclosure.

FIG. 21 depicts another example of a method for providing recommended seat and/or handlebar positions according to the present disclosure.

### DETAILED DISCLOSURE

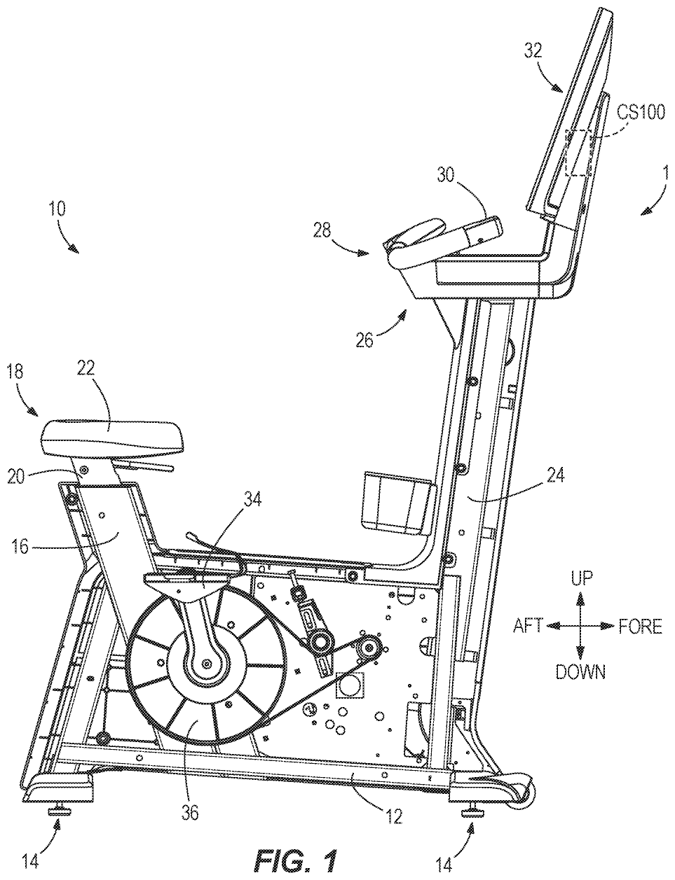

FIG. 1 depicts an exercise machine, which in the illustrated example is an upright bicycle 10. The upright bicycle 10 has a base frame 12 with a pair of ground supporting members 14 configured to be positioned on a floor, as well as a generally vertically extending rear support column 16. The rear support column 16 is configured to support a second frame 18, which as illustrated includes a seat post 20 that supports a seat 22 upon which a user may sit to perform the exercise motion. The second frame 18 is manually moveable up and down relative to the rear support column 16 in a telescoping arrangement. In particular, the seat post 20 is telescopically movable upwardly with respect to the rear support column 16 to raise the seat 22 and telescopically movable downwardly with respect to the rear support column 16 to lower the seat 22. The second frame 18 may also be moveable in a manner known in the art or in a manner described further below.

The base frame 12 of the upright bicycle 10 also includes a generally vertically extending front support column 24 that supports a third frame 26, which as illustrated supports a handlebar 28. The handlebar 28 includes handles 30 that are configured to optionally be gripped by the user when performing the exercise motion. The third frame 26 is moveable relative to the base frame 12, here in a sliding arrangement in which the third frame 26 is manually moveable fore and aft. The present disclosure also contemplates exercise machines in which the third frame 26 is also or alternatively moveable upwardly and downwardly. Additional information regarding the manual movement of the second frame 18 and the third frame 26 relative to the base frame 12 is provided below.

The third frame 26 also supports a display device 32 that displays conventional information for the user, such as a list of available exercise programs for selection, an elapsed time, the user's heart rate, guidance from a trainer, and/or the like. Since the display device 32 is supported by the third frame 26, the display device 32 is also moveable relative to the base frame 12 along with the handlebars 28. It should be recognized that the present disclosure also contemplates exercise machines in which fewer or additional frames are moveable relative to the base frame 12 (e.g., the third frame 26 not being moveable relative to the base frame 12, or the display device 32 being supported in a manner such that it remains stationary relative to the base frame 12 when the handlebars 28 are moved relative to the base frame 12).

As is conventional, the upright bicycle 10 also has foot pedals 34 with which a user sitting on the seat 22 and grasping the handles 30 may perform a cycling or pedaling type of exercise motion. A conventional resistance mechanism, such as a flywheel 36, is coupled to the foot pedals 34 and provides resistance to the exercise motion. A speed sensor 27 is also provided, which detects a speed at which the exercise motion is performed, such as a rotary encoder that measures an RPM of the foot pedals 34.

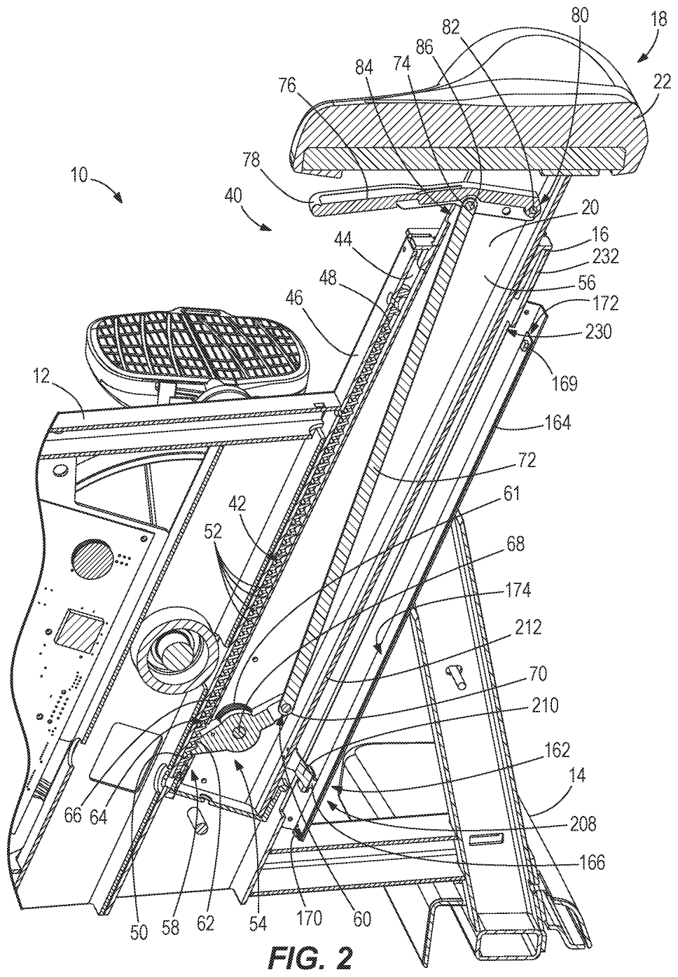

FIG. 2 illustrates one example of a conventionally known adjustment mechanism 40 for moving the second frame 18 up and down relative to the base frame 12. It should be recognized that while the adjustment mechanism 40 is discussed in the context of moving a seat 22, a similar mechanism may also be used adjusting a third frame supporting handlebars. A rack 42 is positioned within an interior 44 of the rear support column 16 and coupled to a front wall 46 of the rear support column 16, such as via welding or threaded fasteners. In this manner, the rack 42 remains stationary relative to the base frame 12. The rack 42 extends between a first end 48 and a second end 50 with teeth 52 therebetween.

A lock member 54 is positioned within an interior 56 of the seat post 20, whereby the seat post 20 is positioned within the interior 44 of the rear support column 16. The lock member 54 extends from a first end 58 to a second end 60. The first end 58 has teeth 62 and extends through an opening 64 in a front face 66 of the seat post 20 such that the teeth 62 mesh with the teeth 52 of the rack 42. The lock member 54 is pivotally coupled to seat post 20 via an axle 68 positioned at a point between the first end 58 and the second end 60. A spring 61 causes a rotational force on the lock member 54 in a clockwise direction such the teeth 62 of the lock member 54 remain meshed with the teeth 52 of the rack 42.

With continued reference to FIG. 2, the second end 60 of the lock member 54 is pivotally coupled to a first end 70 of an elongated rod 72. The elongated rod 72 extends from the first end 70 to a second end 74. A lever 76 is also positioned partially within the seat post 20. The lever 76 extends from a first end 78 to a second end 80 that is pivotally coupled to the seat post 20, specifically via an axle 82. The first end 78 extends through an opening 84 in the front face 66 of the seat post 20 so as to be accessible by the user. The elongated rod 72 discussed above is pivotally coupled at the second end 80 thereof to the lever 76, particularly via an axle 86 positioned at a point between the first end 78 and the second end 80 of the lever 76.

In use, providing an upward force on the first end 78 of the lever 76 causes the lever 76 to rotate clockwise (in the orientation of FIG. 2), which causes upward movement of the elongated rod 72 and, consequently, counterclockwise rotation of the lock member 54 such that the teeth 62 of the lock member 54 un-mesh with the teeth 52 of the rack 42. This allows the user to manually slide the seat post 20 and seat 22 up and down within the rear support column 16 into a desired position for the user to perform the exercise motion. Once the seat 22 is in the desired position, the user releases the lever 76, causing the teeth 62 of the lock member 54 to again mesh with the teeth 52 of the rack 42 to thereby fix the position of seat 22 relative to the rear support column 16. It should be recognized that other mechanisms are also known in the art for adjusting the position of the seat relative to the base frame 12, including those described in the patents incorporated by reference above.

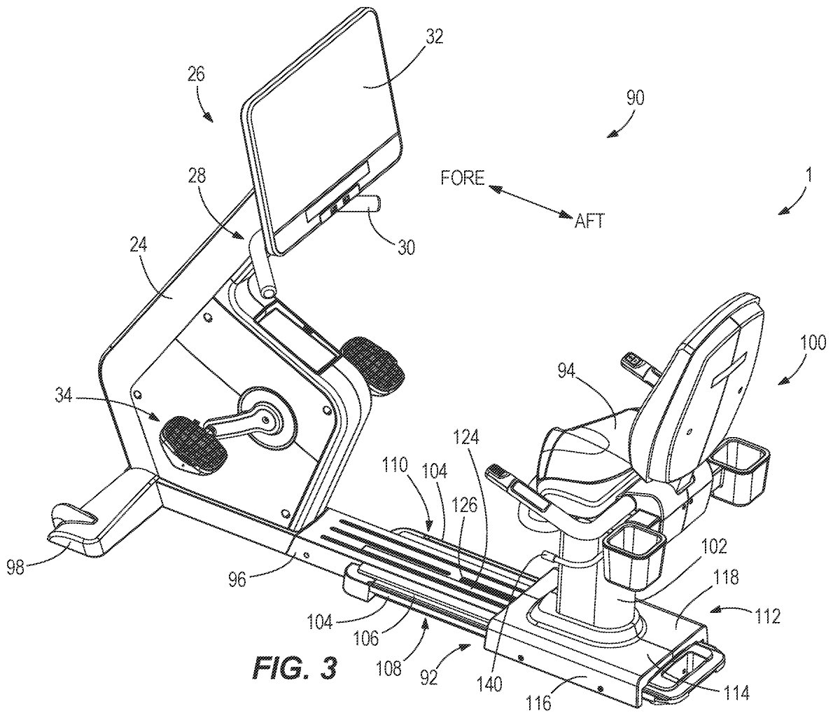

FIG. 3 depicts another exercise machine, here a recumbent bicycle 90, that has an adjustment mechanism 92 similar to the adjustment mechanism 40 discussed above in connection with FIG. 2. However, the adjustment mechanism 92 of FIG. 3 moves an example seat 94 fore and aft rather than up and down. Like the upright bicycle 10 of FIGS. 1 and 2, the recumbent bicycle 90 has a base frame 96 with a pair of ground supporting members 98 configured to be positioned on a floor. For simplicity, additional elements that could be similar to those discussed above for the upright bicycle 10 of FIGS. 1 and 2 are shown with the same reference numbers, such as a generally vertically extending front support column 24 that supports a third frame 26 that supports a handlebar 28 with handles 30 and also supports a display device 32. While not shown in FIG. 3, the third frame 26 may be moveable as discussed further below. The recumbent bicycle 90 also has foot pedals 34 for performing cycling or pedaling type of exercise motion.

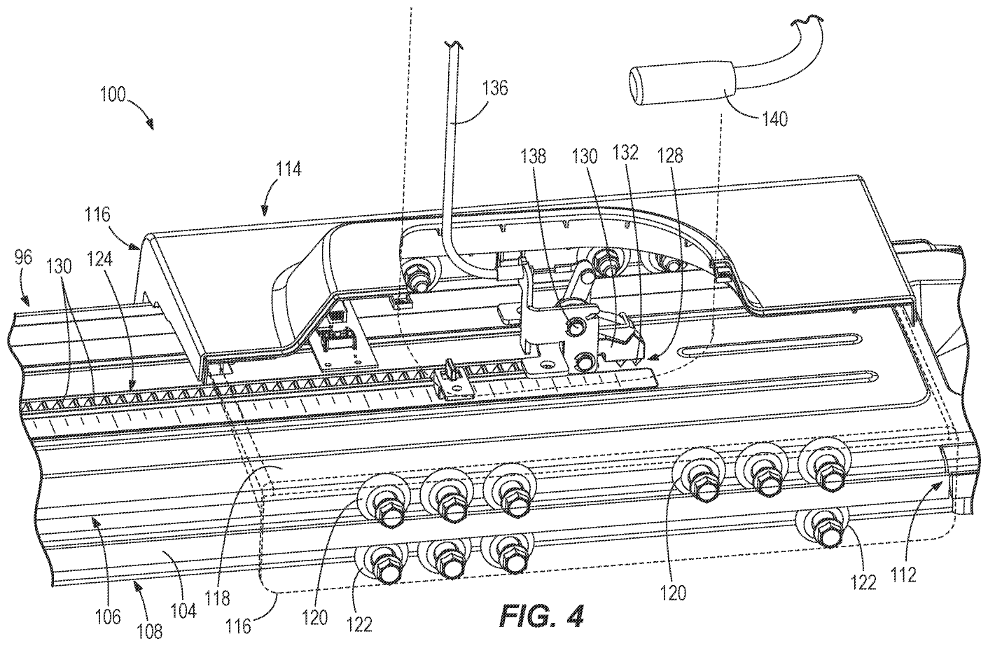

With reference to FIGS. 3 and 4, the base frame 96 supports a second frame 100, which as illustrated includes a seat column 102 that supports the seat 94 upon which a user may sit. The second frame 100 is manually moveable fore and aft relative to the base frame 96. The base frame 96 has a pair of elongated rails 104 that extend in the fore-aft direction. The rails 104 each have an upper surface 106 and a lower surface 108 and extend from a first end 110 to a second end 112. The seat column 102 is coupled to a base 114 of the second frame 100, the base 114 having sides 116 that extend downwardly from a center plate 118. Pairs of upper rollers 120 and lower rollers 122 are rotatably coupled to the sides 116 of the base 114, such as via threaded fasteners. The base 114 is moveably supported on the rails 104 of the base frame 96 such that the upper rollers 120 have rolling contact the upper surface 106 of the rails 104 and the lower rollers 122 have rolling contact the lower surface 108 of the rails 104.

The seat column 102 freely slides or rolls along the rails 104 of the base frame 96 subject to operation of the adjustment mechanism 92. The adjustment mechanism 92 includes a rack 124 that extends between a first end 126 and a second end 128 with teeth 130 that face upwardly from the base frame 96. The rack 124 functions similarly to the rack 42 discussed above, including locking the position of the seat 94 relative to the base frame 96 by meshing between teeth 132 of a lock member 134 with the teeth 130 of the rack 124. In contrast to the mechanisms for engaging and disengaging the lock member 54 with the rack 42 discussed above, the lock member 134 is un-meshed by via providing tension to a cable 136, which pivots the locking member 134 about an axle 138 (in a counterclockwise position in the orientation of FIG. 4) coupling the lock member 134 to the base 114. One example of a commercially available fitness machine with this type of adjustment mechanism is the Life Fitness® Elevation Recumbent Bike. It should be recognized that tension may be provided to the cable 136 in a conventional manner, here via pulling upwardly on a lever 140. Additional information regarding adjusting the seat 94 is provided in the patents incorporated by reference above.

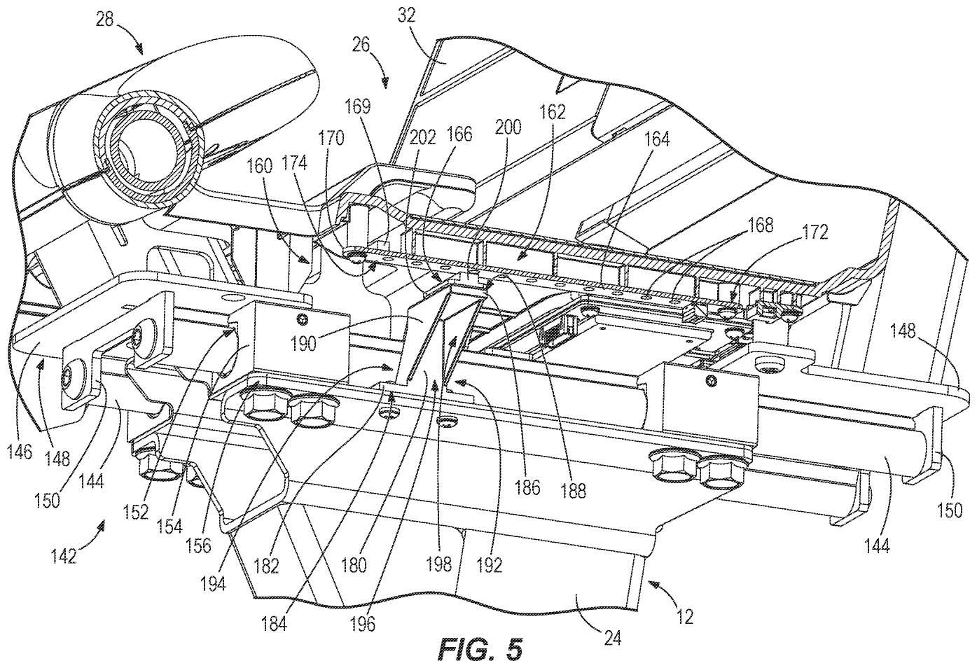

FIG. 5 shows a third frame 26 similar to that shown in FIG. 1 and an adjustment mechanism 142 for moving the third frame 26 relative to the base frame 12, and particularly the front support column 24, that supports the third frame 26. In the illustrated embodiment, the third frame 26 includes a pair of rails 144 that extend parallel to each other in the fore-aft direction. The rails 144 may have circular cross-sections and be coupled to an underside 146 of a base of 148 of the third frame 26 via end plates 150. By way of non-limiting example, the pairs of rails 144 may be coupled to the end plates 150 via welds, fasteners such as bolts, or held in compression between the end plates 150. By way of non-limiting example, the end plates 150 may be coupled to the underside 146 of the base 148 via welds, fasteners, or by being integrally formed with the base 148. Each of the rails 144 is positioned within a bearing 152 that is itself positioned within a housing 154 coupled to a flange 156 on top of the front support column 24. The housing 154 may be coupled to the flange 156 via techniques known in the art, including welds, fasteners, and integral formation.

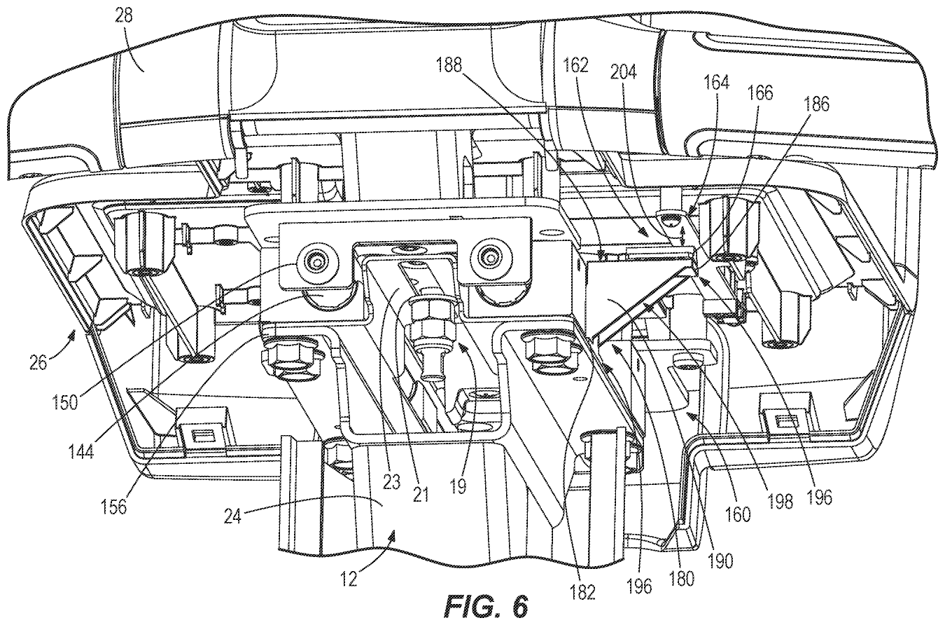

In use, the pair of rails 144 are slidable within the bearings 152 in the fore-aft direction. This allows the user to manually move the third frame 26 into a desired position relative to the base frame 12 to perform the exercise motion. In certain embodiments, the position of the third frame 26 can be locked relative to the base frame 12 once in the desired position, for example via a clamp or other mechanisms known in the art (e.g., the mechanism 19 of FIG. 6, whereby a washer 21 is drawn upwardly against a frame 23 coupled to the flange 156 to prevent movement of the third frame 26). The third frame 26 may be manually moveable via other mechanisms, such as those described for the second frame 18 (FIG. 2), and vice versa. Likewise, both the second frame 18 and the third frame and/or manually moveable in additional or alternative directions (e.g., up and down and/or fore and aft). Additional information regarding adjustment mechanisms for manually moving and locking one frame of an exercise machine relative to another frame is provided in the patents incorporated by reference as listed above.

Through research and development, the present inventors have identified challenges with moving seats and/or handlebars into desired locations for a user to perform an exercise motion with an exercise machine, such as an upright or recumbent stationary bicycle. Users may not have the flexibility to bend forward and see conventional visual markings that indicate a position of the seat and/or handlebar. Likewise, a user may not have the visual ability to see these small markings even if sufficiently flexible, which may be worsened in low light conditions or if the user works out without eyeglasses. Furthermore, in some use cases, seat or handlebar positions are changed during the workout. In these cases, bending to check the position while adjusting the seat and performing the exercise motion may be substantially difficult or impossible. In such cases, the user must either guess the position or stop the workout. Moreover, the present inventors have recognized that some exercise machines provide no visual markings for determining the actual positions of the seat and/or handlebars, which causes the user to guess positions for the seat and/or handlebars.

In addition, the present inventors have recognized that users often have difficulty remembering their desired position for the seat and/or handlebars. Thus, even if the user makes the effort of checking the visual markings indicating the actual positions of the seat and/or handlebars, they are still left guessing or using trial and error to relocate the desired positions to perform the exercise.

As such, the present inventors have recognized that it would be advantageous to provide an exercise machine that detects the actual position of the seat and/or handlebars and displays that actual position on a display device for the user to easily see. Likewise, the present inventors have recognized that it would be advantageous for the exercise machine to store the actual position of the seat and/or handlebars as a stored position once in the desired position. This stored position can then be later retrieved and referenced as the desired position such that the user can manually move the seat and/or handlebars until the actual position matches or is near the desired position.

FIGS. 5 and 6 show a sensor assembly 160 for detecting an actual position of the third frame 26 relative to the base frame 12 (FIG. 1). In the illustrated example, the sensor assembly 160 includes a sensor 162 that provides contactless, solid-state position sensing. The sensor 162 has a circuit board 164 and a target 166 (here including a magnet) that is moveable relative to the circuit board 164 (and vice versa). The circuit board 164 includes a number of coils 168 that are electrically excited when the target 166 is positioned in close proximity thereto, which is detected by an integrated circuit (IC) 169. In particular, the IC 169 determines which of the coils 168 the target 166 is positioned near, thereby determining a relative position between the target 166 and the circuit board 164. By way of example, CambridgeIC of Cambridge, UK produces sensors suitable for the present application, such as the CAM312 as the IC 169, a linear sensor, rotary sensor, or arc position sensor as the circuit board 164, and an inductive target as the target 166.

The circuit board 164 extends between a first end 170 and a second end 172 with a sensing face 174 extending therebetween. The coils 168 are positioned on the sensing face 174. The circuit board 164 is coupled to the third frame 26, here to an underside 176 of the third frame 26 via fasteners (e.g., screws or bolts) such that the sensing face 174 faces downwardly toward the flange 156 of the front support column 24. The circuit board 164 is positioned so as to extend between the first end 170 and the second end 172 in the fore-aft direction. In this manner, the circuit board 164 is moveable with the third frame 26 relative to the base frame 12.

The target 166 is coupled to the flange 156 of the front support column 24 via a mounting bracket 180. In the orientation of FIG. 5, the mounting bracket 180 extends in the up and down direction between a first plate 182 at a first end 184 and a second plate 186 and a second end 188, in the fore and aft direction between a third end 190 and a fourth end 192, and laterally between a fifth end 194 and a sixth end 196. The first plate 182 is coupled to the top of the flange 156 via fasteners or other known techniques. The second plate 186 is cantilevered at the sixth end 196 of the mounting bracket 180 so as to extend laterally outwardly relative to at the first plate 182. Ribs 198 are provided to support the second plate 186.

With continued reference to FIGS. 5 and 6, the target 166 has a housing 200 with a mounting flange 202. A resonance producing element such as a magnet (not shown) is provided within the housing 200. The target 166 is coupled to the second plate 186 of the mounting bracket 180 via threaded fasteners that extend through the mounting flange 202 and into the second plate 186. It should be recognized that other techniques are contemplated for coupling the target 166 to the mounting bracket 180 and likewise the mounting bracket to the flange 156 of the front support column 24.

The target 166 is therefore static relative to the front support column 24 and thus the base frame 12. The mounting bracket 180 positions the target 166 to be a known distance from the circuit board 164, in this case having a consistent gap 204 of 2.0 mm therebetween (FIG. 6). It should be recognized that other configurations are also contemplated by the present disclosure depending on the fitness machine, type of sensors, and the like, such as those in which the gap 204 is (e.g., 1.0 mm, 1.5 mm, 3.0 mm, etc.). The circuit board 164 and the target 166 are positioned such that the target 166 remains aligned with and in this close, consistent proximity to the circuit board 164 throughout the entire range of motion in which the third frame 26 can be moved relative to the base frame 12. Therefore, the sensor 162 is configured to output the position of the target 166 relative to the circuit board 164 as the third frame 26 is moved, which corresponds to the actual position of the third frame 26 relative to the base frame 12.

It should be recognized that the present disclosure also contemplates other types of sensors for detecting the position of one frame (e.g., the second frame 18 of FIG. 2 and/or the third frame 26 of FIG. 5) relative to the base frame 12. By way of example, these other types of sensors include optical sensors with choppers, string pots, Hall-effect sensors, and rotary encoders (e.g., a rack gear engaging with the rack 42 of FIG. 1).

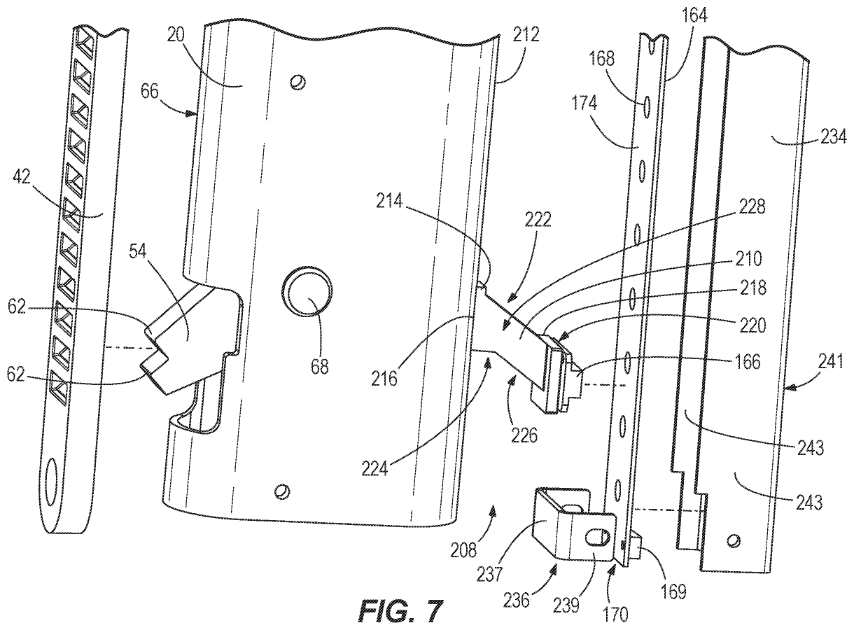

With reference to FIG. 2, a sensor 208 may also or alternatively be provided to detect the actual position of the second frame 18 relative to the base frame 12, such as to detect the position of the seat 22 for the upright bicycle 10. With additional reference to FIG. 7, a mounting bracket 210 similar to the mounting bracket 180 of FIG. 5 is coupled to a rear face 212 of the seat post 20 opposite the front face 66. The sensor 208 includes a mounting bracket 210 that extends in the generally fore and aft direction between a first plate 214 at a first end 216 and a second plate 218 and a second end 220, in the generally up and down direction between a third end 222 and a fourth end 224, and laterally between a fifth end 226 and a sixth end 228. The first plate 214 is coupled to the rear face 212 of the seat post 20 via fasteners or other known techniques. The second plate 218 is cantilevered at the fourth end 224 of the mounting bracket 210 so as to extend downwardly relative to at the first plate 214 in the orientation shown in FIG. 7.

In use, the mounting bracket 210 moves as the seat post 20 is moved within the rear support column 16 in the manner described above. A slot 230 is formed in a rear face 232 of the rear support column 16 (FIG. 2). The mounting bracket 210 is coupled to the seat post 20 such that the second plate 218 is positioned outside and aft of the rear support column 16.

The sensor 208 further includes a sensor that may be the same as or similar to the sensor 162 discussed above. Although the type, shape, length, and/or orientation of sensor elements may vary from that shown, the same reference numbers described above are used in FIG. 7 for simplicity. Thus, the sensor 208 of FIG. 7 also provides contactless, solid-state position sensing via a circuit board 164 and a target 166 that is moveable relative to the circuit board 164. The circuit board 164 includes a number of coils 168 that are electrically excited when the target 166 is positioned in close proximity thereto, which an integrated circuit (IC) 169 uses to determine a relative position between the target 166 and the circuit board 164. The target 166 is coupled to the second plate 218 of the mounting bracket 210 outside of the rear support column 16. In alternative embodiments the target 166 may be coupled to the seat post 20 without a mounting bracket 210, or with a mounting bracket having a different size, configuration, and/or the like.

With continued reference to FIGS. 2 and 7, one or more mounting brackets 236 are positioned on the rear face 232 of the rear support column 16 bases 237 of the mounting brackets 236 may be coupled to the rear face 232 via welds, fasteners, or integral formation. Two tabs 239 extend perpendicularly away from each of the bases 237. A u-shaped housing 234 is positioned on the rear face 232 of the rear support column 16, the housing 234 having a base 241 with two sides 243 extending perpendicularly therefrom. The two sides 243 of the housing 234 are coupled to the two tabs 239 of each of the mounting brackets 236 such that the slot 230 is covered by the housing 234. The housing 234 is coupled to the mounting brackets 236 via fasteners, welds, or other techniques known in the art. In alternative embodiments, the housing 234 may be integrally formed with the rear support column 16, and/or the sensor 208 may be positioned directly inside the rear support column 16.

The circuit board 164 of the sensor 162 is also coupled to the mounting bracket 236 and/or to the housing 234, such as via fasteners, adhesives, or other techniques known in the art. In this manner, the circuit board 164 is coupled to the rear support column 16 such that the coils 168 positioned on the sensing face 174 of the sensor 162 face the seat post 20 and the target 166. Wires (not shown) extend from the sensor 162 to the control system CS100 discussed below, allowing both the sensor 162 and the wires to be protected within the housing 234. In other words, the housing 234 prevents movement of the seat post 20 from damaging the sensor 162 or wiring thereof.

In contrast to the arrangement of the sensor 162 shown in FIGS. 5 and 6, the sensor 208 configuration of FIGS. 2 and 7 provides that the target 166 with the second frame 18 as the second frame 18 is manually moved relative to the base frame 12, whereby the circuit board 164 remains static relative to the base frame 12. However, it should be recognized that either configuration may be reversed without alternative the function of the IC 169 detecting the position of the sensor 162 relative to the circuit board 164, and thus the second frame 18 and/or third frame 26 relative to the base frame 12.

In this manner, the sensor 208 detects the actual position of the second frame 18 and thus the seat 22 relative to the base frame 12 as the user manually moves the seat 22 in the up and down direction.

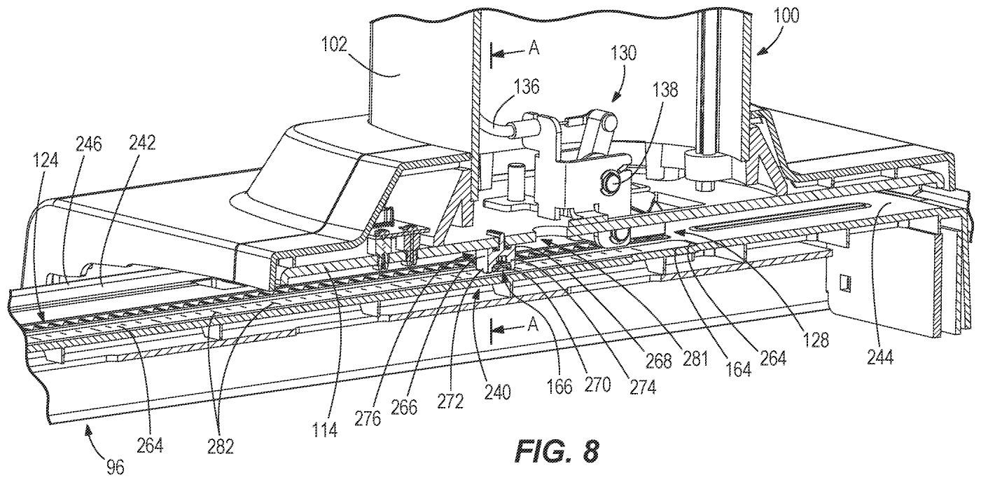

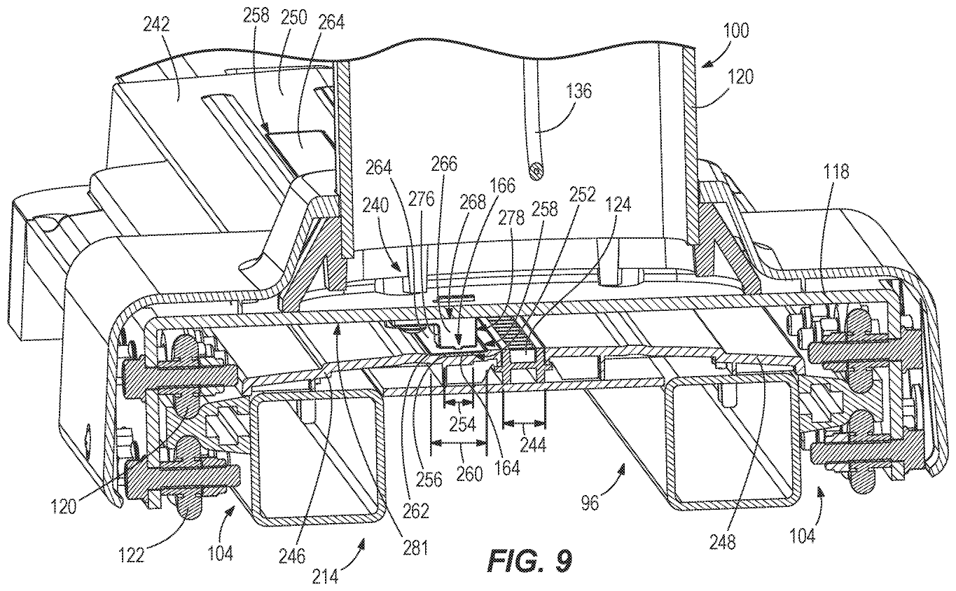

FIGS. 8 and 9 illustrate another sensor 240 for detecting the actual position of the second frame 100 relative to the base frame 96, in this case shown with the recumbent bicycle 90 of FIGS. 3 and 4. The sensor 240 similar to the sensor 162 discussed above in connection with FIGS. 5 and 6. Although the type, shape, length, and/or orientation of sensor elements may vary from that shown, the same reference numbers described above are used in FIGS. 8 and 9 for simplicity. Thus, the sensor 240 of FIGS. 8 and 9 also provides contactless, solid-state position sensing via a circuit board 164 and a target 166 that is moveable relative to the circuit board 164. The circuit board 164 includes a number of coils 168 (see FIG. 7) that are electrically excited when the target 166 is positioned in close proximity thereto, which an integrated circuit (IC) 169 (see FIG. 7) uses to determine a relative position between the target 166 and the circuit board 164.

A casing 242 covers a portion of the base frame 96 between the rails 104 upon which the second frame 100 rolls, as discussed above. A first channel 244 (FIG. 9) is provided within the casing 242, here between a space provided between a left side shell 246 and a right side shell 248 that together form the casing 242. The first channel 244 is configured such that the rack 124 is at least partially positioned within the first channel 244 and the teeth 130 of the rack 124 remain exposed from above when the casing 242 and the rack 124 are each coupled to the base frame 96.

The casing 242 has an outer surface 250 with a second channel 252 that extends inwardly from the outer surface 250, particularly towards the base frame 96. The second channel 252 has a length (not shown), width 254, and a depth 256 configured to position the circuit board 164 therein. The casing 242 also includes a third channel 258 that extends inwardly from the outer surface 250, which is approximately centered over the second channel 252. In other words, the second channel 252 can be considered a channel that extends further inwardly, or towards the base frame 96, from the bottom of the third channel 258. The third channel 258 has a length (not shown), width 260, and a depth 262 configured to position a cover 264 therein such that the cover 264 is at least partially recessed within the third channel 258. The cover 264 may have a length, width, and height substantially similar to the length, width 260, and depth 262 of the third channel 258 and are not separately shown for clarity. Similarly, the length and width of the cover 264 are greater than the length and the width of the circuit board 164 such that the circuit board 164 is entirely covered by the cover 264 when the cover 264 is centered thereon.

The cover 264 may be a decal that adheres to the casing 242 to thereby seal and protect the circuit board 164 below the outer surface 250 of the casing 242. By way of example, the cover 264 may alternatively be retained within the third channel 258 via a press fit arrangement, fasteners, or other decals positioned over the cover. The present disclosure also contemplates configurations in which the circuit board 164 and the cover 264 are combined, and/or the cover 264 not being recessed within a third channel 258 in the casing 242.

With continued reference to FIGS. 8 and 9, the sensor 162 further includes a target 166 that is coupled to base 114 of the second frame 100. In particular, the target 166 is contained within a housing 266 that extends between a first end 268 and a second end 270 in the up and down direction (in the orientation shown in FIG. 8), between a third end 272 and a fourth end 274 in the fore and aft direction, and laterally between a fifth end 276 and a sixth end 278 (FIG. 9). The first end 268 of the housing 266 is coupled to an underside 281 of the base 114 of the second frame 100. The target 166 therefore moves with the second frame 100, whereas the circuit board 164 remains stationary relative to the base frame 96. The housing 266 protects the target 166 and performs a similar function to the mounting bracket 180 discussed above (see e.g., FIG. 3), namely, positioning the target 166 so as to be aligned with and detectable by the circuit board 164. As with the mounting bracket 180 discussed, a consistent gap (e.g., see gap 204 of FIG. 6) is maintained between the target 166 and the circuit board 164 across the full range of motion of the second frame 100 relative to the base frame 96.

The cover 264 also includes markings 282 (FIG. 8) for visually indicating the actual position of the second frame 100 relative to the base frame 96 separately from the sensor 240, as is known in the art. Since the fore-aft positions of the target 166, circuit board 164, and cover 264 are each known, the sensor 162 may be calibrated such that the output thereof when reading the position of the target 166 relative to the circuit board 164 corresponds to the same actual position visible via the marking 282 on the cover 264. In this manner, there are two independent mechanisms for determining the actual position of the second frame 100 relative to the base frame 96.

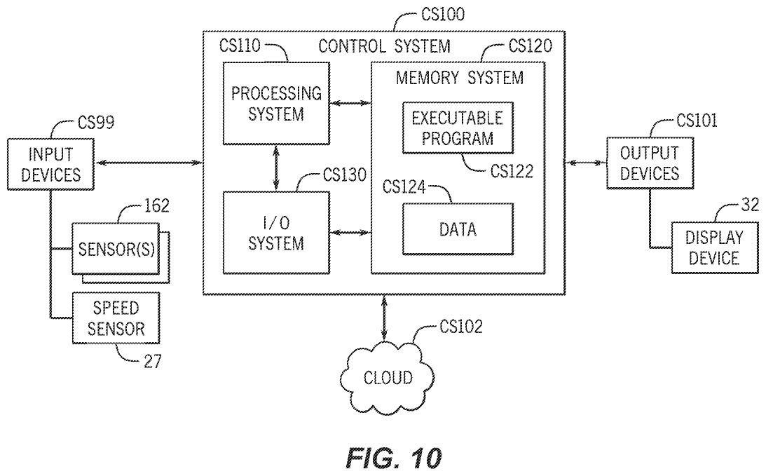

Additional information is now provided regarding an example control system CS100 of FIGS. 1 and 10 that receives the actual position detected by the sensor 162. While the following description references the upright bicycle 10 of FIG. 1, it should be recognized that the same teachings apply to all embodiments described above, and any other exercise machines not expressly shown herein. These other exercise machines can be any type having one frame that is moveable relative to another, which may incorporate the sensors 162 described herein to detect the actual position of the one frame relative to the other. By way of example, these include weight-press machines in which a starting position or range of motion is adjustable by moving one frame relative to a base frame, any exercise machine with an adjustable seat, or any exercise machine with adjustable handlebars.

Referring to FIG. 10 and the upright bicycle 10 of FIGS. 1 and 2, each of the sensors 162 discussed herein is an input device CS99 to the control system CS100. As discussed further below, the control system CS100 receives the actual position detected by the sensor 162 of the second frame 18 relative to the base frame 12. Example output devices CS101 of the control system CS100 can include the display device 32. As is discussed further below, the control system CS100 is configured such that the display device 32 displays the actual position detected by the sensor 162 to help the user position the second frame 18 relative to the base frame 12. The control system CS100 may also control various functions of the exercise machine, including changing the resistance or the incline of the upright bicycle 10, or be a subset of a larger control system performing these functions.

Certain aspects of the present disclosure are described or depicted as functional and/or logical block components or processing steps, which may be performed by any number of hardware, software, and/or firmware components configured to perform the specified functions. For example, certain embodiments employ integrated circuit components, such as memory elements, digital signal processing elements, logic elements, look-up tables, or the like, configured to carry out a variety of functions under the control of one or more processors or other control devices. The connections between functional and logical block components are merely exemplary, which may be direct or indirect, and may follow alternate pathways.

In certain examples, the control system CS100 communicates with each of the one or more components of the upright bicycle 10 via a communication link CL, which can be any wired or wireless link. The control system CS100 is capable of receiving information and/or controlling one or more operational characteristics of the upright bicycle 10 and its various sub-systems by sending and receiving control signals via the communication links CL. In one example, the communication link CL is a controller area network (CAN) bus; however, other types of links could be used. It will be recognized that the extent of connections and the communication links CL may in fact be one or more shared connections, or links, among some or all of the components in the upright bicycle 10. Moreover, the communication link CL lines are meant only to demonstrate that the various control elements are capable of communicating with one another, and do not represent actual wiring connections between the various elements, nor do they represent the only paths of communication between the elements. Additionally, the upright bicycle 10 may incorporate various types of communication devices and systems, and thus the illustrated communication links CL may in fact represent various different types of wireless and/or wired data communication systems.

The example control system CS100 of FIG. 10 can be a computing system that includes a processing system CS110, memory system CS120, and input/output (I/O) system CS130 for communicating with other devices, such as input devices CS99 and output devices CS101. Furthermore, the control system CS100 includes the input/output (I/O) system CS130 to transmit information to an example cloud CS102 and/or obtain information from the cloud CS102. The processing system CS110 loads and executes an executable program CS122 from the memory system CS120, accesses data CS124 stored within the memory system CS120, and directs the upright bicycle 10 to operate as described in further detail below.

The processing system CS110 may be implemented as a single microprocessor or other circuitry or be distributed across multiple processing devices or sub-systems that cooperate to execute the executable program CS122 from the memory system CS120. Non-limiting examples of the processing system include general purpose central processing units, application specific processors, and logic devices.

The memory system CS120 may comprise any storage media readable by the processing system CS110 and capable of storing the executable program CS122 and/or data CS124. The memory system CS120 may be implemented as a single storage device or be distributed across multiple storage devices or sub-systems that cooperate to store computer readable instructions, data structures, program modules, or other data. The memory system CS120 may include volatile and/or non-volatile systems and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example.

As discussed above, the present inventors have recognized that it is beneficial to display the actual position of the second frame 18 (and thus the seat 22) relative to the base frame 12 on the display device 32 to assist the user in moving the seat 22 into the desired position. The actual position can be displayed during a workout, during an initial portion of the workout, when the sensor 162 detects that the actual position is changing, and/or other instances at which the user would be interested in knowing this information. Other example instances include displaying during a workout summary, within recorded information stored in a login account or application, or immediately upon logging into a fitness machine.

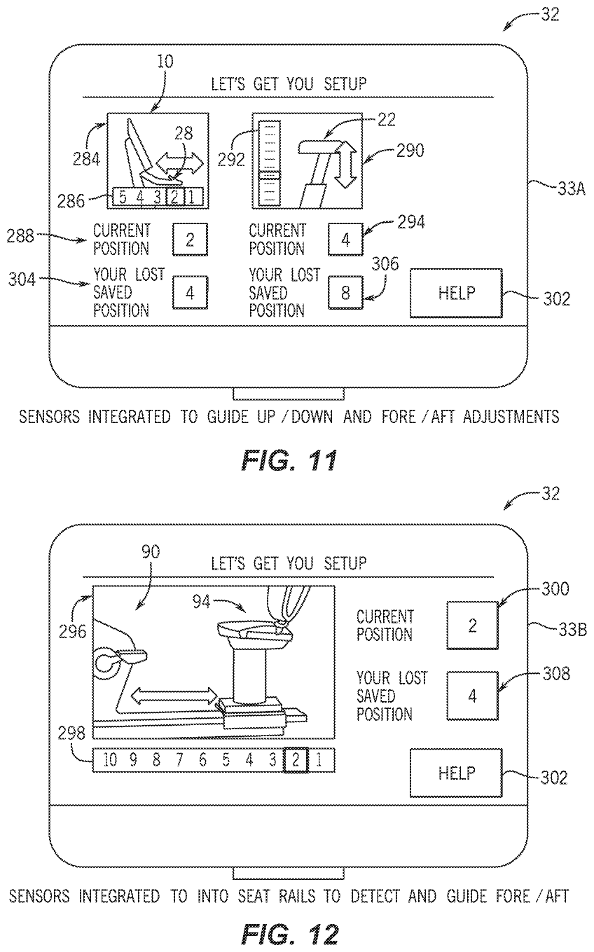

FIGS. 11 and 12 illustrate graphical user interfaces or displays 33A, 33B of the display device 32 of FIGS. 1 and 3. In the illustrated example of FIG. 11, the first display 33A shows the actual positions corresponding to the seat 22 and the handlebars 28 of the example upright bicycle 10 of FIG. 1. In the illustrated example of FIG. 12, the second display 33B shows the actual position corresponding to the seat 94 of the example recumbent bicycle 90 of FIG. 3. Furthermore, the first display 33A of FIG. 11 includes a first graphic 284 depicting the actual position of the handlebars 28 based on a detection from the sensor 162 within a range 286 of possible handlebar positions. Furthermore, the first display 33A includes a visual indication of an actual or current position 288 of the handlebars 28. In some examples, the range 286 of possible handlebar positions (and likewise, seat positions), are stored in the memory system CS120 of the control system CS100. In the example shown, the range 286 spans from handlebar positions 1 through 5, with the actual position 288 being 2. The display device 32 of FIG. 11 further provides a second graphic 290 depicting the actual position of the seat 22 based on a detection from the sensor 162 within a range 292 of possible seat positions. Furthermore, the first display 33A includes a visual indication of an actual or current position 294 of the seat 22. In the example shown, the range 292 spans from seat positions 1 through 10, with the actual position 294 being 4.

The display device 32 of FIG. 12 shows similar information for the recumbent bicycle 90, providing a graphic 296 depicting the actual position of the seat 94 based on a detection from the sensor 162 within a range 298 of possible seat positions. Furthermore, the second display 33B includes a visual indication of an actual or current position 300 of the seat 94. In the example shown, the range 298 spans from seat positions 1 through 10, with the actual position being 2. The example display device 32 also displays a help button 302 that, when selected, provides guidance for the user on how to manually move the seat and/or handlebars (e.g., including how to unlock and lock the position once in the desired position, and/or to save the current position as a stored position).

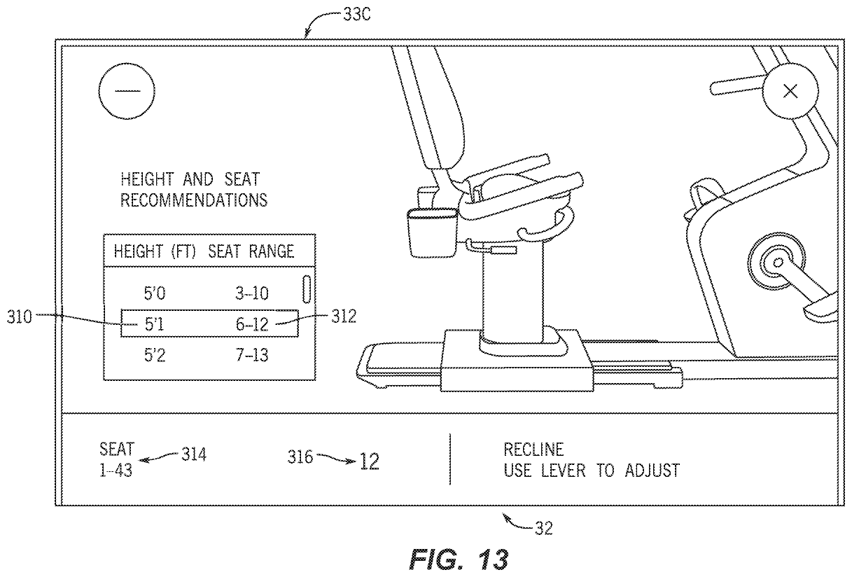

FIG. 13 illustrates a display 33C of a display device 32 showing the height 310 of the user, the corresponding recommended range 312 of seat positions, the total range 314 of possible seat positions, and the actual position 316 as read by the sensor in the manner discussed above. This guidance may be particularly useful for a user just starting out, or a user than cannot remember their previous desired position for the seat.

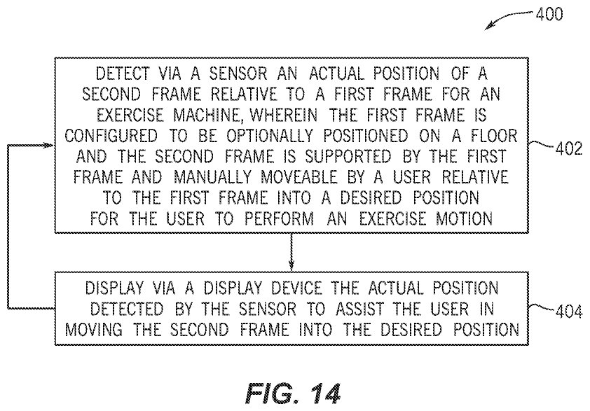

FIG. 14 shows an example method 400 for controlling exercise machines according to the present disclosure, including causing display devices to produce the displays 33A and 33B of FIGS. 11 and 12, which utilizes the elements described above. In particular, step 402 provides for detecting, via a sensor, an actual position of a second frame (e.g., the second frame 18 of FIG. 1, the third frame 26 of FIG. 1, etc.) relative to a first frame (e.g., the first frame 12 of FIG. 1) for an exercise machine (e.g., the upright bicycle 10 of FIG. 1). In some examples, the first frame is configured to be positioned on a floor and the second frame is supported by the first frame and manually moveable by a user relative to the first frame into a desired position for the user to perform an exercise motion. In some examples, at step 402, the control system CS100 (e.g., the processing system CS110) detects, via the sensor, the actual position of the second frame relative to the first frame for the exercise machine. Step 404 then provides for causing the display devices to display the actual position detected by the sensor, via the display device, to assist the user in moving the second frame into the desired position.

It should be recognized that the present disclosure also contemplates other methods for providing the same functionality to the user, such as those in which the user selects a seat and/or handlebar adjustment setting within a graphical user interface of a display screen. This may begin the process of the system detecting the positions of the seat and/or handlebar, for example activating the sensors described above.

Additionally, while each of the methods 400, 500, and 600 of FIGS. 14-16 are shown to repeat at the ends thereof, it should be recognized that the present disclosure also contemplates methods in which the methods end. In other words, the present disclosure contemplates methods in which the steps of measuring (and in certain cases communicating positions of the movable frames for the exercise machine) are repeated, remain ongoing, or are performed only a limited number of times.

As discussed above, the present inventors have further recognized that it is beneficial to store the actual positions of the seat and/or handlebars as stored positions for later reference. In some examples, the actual positions are stored when requested by the user (e.g., by selecting “Save current position” within the help button 302 menu). In some examples, the actual positions are stored automatically as described further below. In the illustrated example of FIG. 11, the display device 32 further displays a stored position 304 of the handlebars 28 and a stored position 306 of the seat 22. Likewise, in the illustrated example of FIG. 12, the display device 32 further displays a stored position 308 of the seat 94. Viewing the stored positions 304, 306, 308 displayed on the display device 32 assists the user in manually moving or positioning the seat and/or handlebars back to desired positions to perform the exercise motion with the exercise machine. For example, the user can compare the actual positions 288, 294, 300 with the stored positions 304, 306, 308 while manually moving the seat and/or handlebars until the positions match.

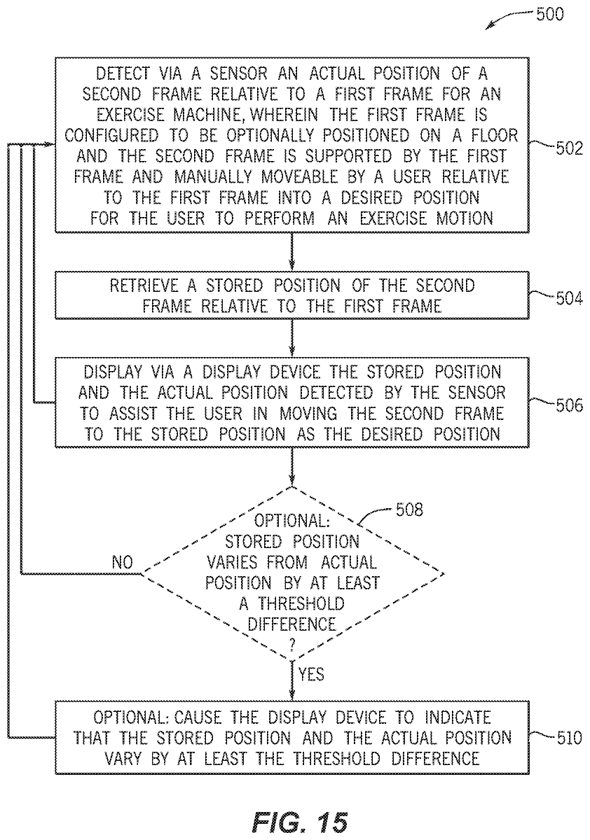

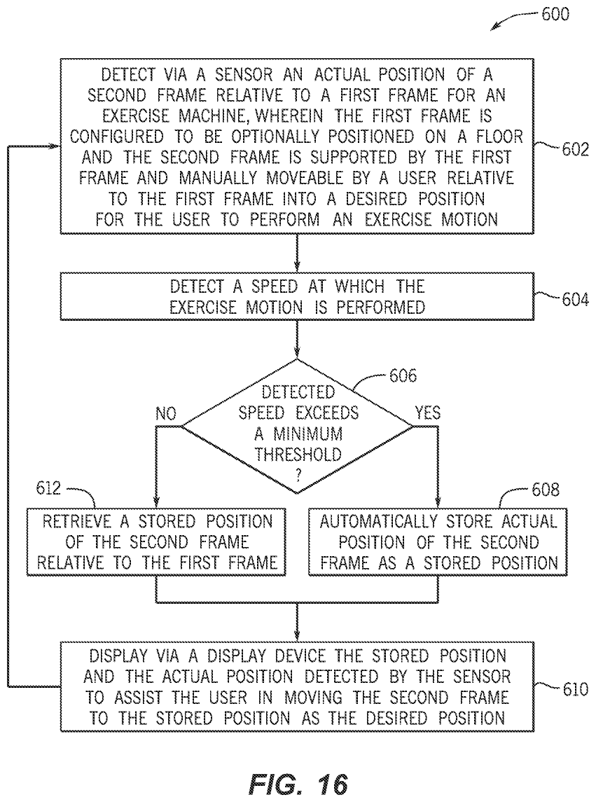

Exemplary methods 500, 600 relating to the storage and retrieval of stored positions as the desired position for moving a frame are provided in FIGS. 15 and 16. Steps 502 and 602 of the methods 500 and 600 may proceed in the same manner as steps 402 and 404 discussed above. In some examples, at steps 502 and 602, the control system CS100 (e.g., the processing system CS110) detects, via the sensor, the actual position of the second frame relative to the first frame for the exercise machine. For the method 500, step 504 provides for retrieving a stored position of the second frame relative to the first frame, which may be stored in the memory system CS122. Step 506 then proceeds in a similar manner to step 404 discussed above but includes displaying the stored position retrieved in step 504 in addition to the actual position to assist the user in moving the second frame to the stored position.

In certain embodiments, the method 500 further includes comparing the stored position and the actual position, such as to determine whether the stored position varies from the actual position by at least a threshold difference (step 508, e.g., 2 positions, 4 position, 3.0 cm, or other stored thresholds). If so, the method continues to step 510, which provides for causing the display device to indicate the results of the comparison from step 508. In the example shown, step 510 provides for causing the display device to produce a display that indicates when the stored position and the actual position do vary by at least the threshold difference, such as by showing the stored position and the actual position, showing a written message or warning that the actual does not match the stored position, and/or the like. In other examples, step 510 may provide for also or alternatively causing the display device to indicate when the stored position and the actual position match and/or when the stored position and the actual position are within the threshold difference. In certain examples, if none of the selected conditions among those listed above for step 510 are met, step 510 is skipped. In other words, if the method 500 is configured such that step 510 causes the display device to produce a display indicating when the stored position and the actual position vary by at least the threshold difference, but the stored position and the actual position do not vary by at least the threshold difference, in certain examples the method concludes without producing any further indication of this status.

Returning to step 508, if instead the stored position is determined to not vary from the actual position by the threshold amount (and/or other conditions described above) in step 508, the process may end or return to step 502 as shown.

The example control system CS100 can be further configured to display an indication on the display device 32 when the actual position detected by the sensor is different than the stored position. In further examples, this indication may be provided only when the actual position varies from the stored position by a threshold difference (e.g., 2 position levels or 5% of the total range of possible positions). By way of example, the indication may be a display on the display device 32 stating “Current Handlebar Position is Closer than Stored Position”. The indications may also or alternatively be a change in font, size, or color of information being displayed on the display device 32, flashing, and/or tactile or audible indications.

The present inventors have identified that it can be advantageous to automatically store the actual position of the seat and/or handlebar from one exercise session for use in the next exercise session (e.g., being saved in the memory system CS120 with information stored for the login profile of the user). However, the present inventors have further identified a need to limit when the actual positions of the seat and/or handlebar are saved. In other words, there is a need to determine when the actual positions correspond to the user's desired positions for performing the exercise motion, versus the seat and/or handlebar being in a different position for another reason. For example, some users may slide the seat aftwardly when exiting the exercise machine to provide additional room. It would be undesirable to save this aftward position as the stored position for future reference as this would later guide the user to the wrong position for performing the exercise motion.

In one example, the control system CS100 is configured to store the actual positions of the seat and/or handlebar only when the speed of the exercise motion exceeds a minimum threshold. The minimum threshold is selected to correspond to the exercise machine being used for performing the exercise motion, rather than a slower speed as the exercise machine coasts down to a stop as the user is exiting the exercise machine. By way of example, the minimum threshold may correspond to a stationary bicycle being pedaled at a speed equivalent to 5 mph. As discussed above, the speed of the exercise motion may be determined using the speed sensor 27 that detects the RPM in which pedals are rotating (e.g., FIG. 1). This is further depicted in the exemplary method 600 of FIG. 16. Steps 602, 610, and 612 may proceed in a similar manner to steps 502, 504, and 506, respectively. As described above, step 604 provides for detecting a speed at which the exercise motion is being performed. Step 606 then provides for comparing the speed from step 604 to a minimum threshold, which may correspond to a speed at which the user is fully using the exercise device, rather than simply bumping pedals while getting on, or warming up. If the speed exceeds this minimum threshold in step 606, the process continues to automatically storing the actual position of the second frame in step 608 as the stored position when the speed of the exercise motion exceeds this minimum threshold. The process may then proceed to step 610. If instead the speed in which the exercise machine is being operated does not exceed the minimum threshold in step 606, the process proceeds to step 612, retrieving a stored position that is already saved in memory before proceeding to step 610.

In additional examples, the control system CS100 is further configured to receive height information for the user (e.g., either entered by the user, or stored in the memory system CS120 with information stored for the login profile of the user) and to determine a recommended position for the seat and/or handlebars based on this height information. The determination of the recommended positions based on height information may be provided by referencing a table or algorithm of information stored in the memory system CS120. The table or algorithm may be based on empirical data and/or based on biomechanical standards known in the art. The recommended positions may be a single position or a range of positions for each of the seat and the handlebars, which may also vary by exercise machine. The control system CS100 then compares the actual position for the seat and/or handlebars to the recommended positions and indicates when the recommended position and the actual position vary by a threshold difference. By way of example, the control system CS100 may provide an indication via the display device 32 (e.g., “Seat Position outside Recommended Range”) when the actual position is at least 3 positions outside of the range of recommended positions.

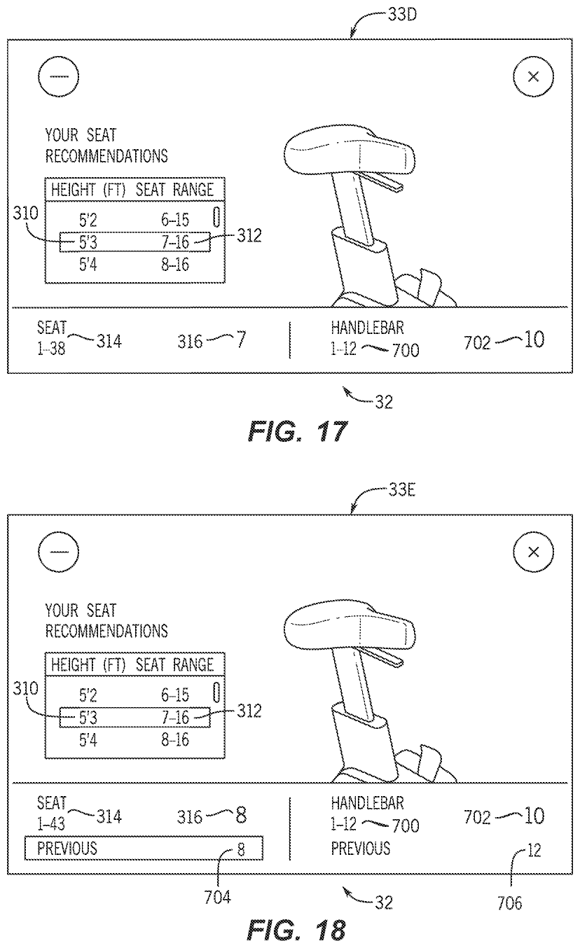

FIGS. 17-19 depict additional examples of displays 33D-33F, respectively, produced via display devices 32 according to the present disclosure. For brevity, display features that may represent the same information discussed above is shown with like-reference numbers and not repeated here. FIGS. 17-19 depict examples in which both seat and handlebar positions are displayed via the display device 32 together, which may be based on a height of the user as discussed above. FIG. 17 may represent a display 33D in which the user is either not logged in or is logged in but has not entered height information (and/or such height information or stored positions for the seat and/or handlebars have not been stored in memory). As with the information pertaining to the seat, the display 33D indicates a total range 700 of available handlebar positions, as well as the actual position 702 of the handlebar as determined via a method described above. A handlebar recommendation may also be provided based on an inputted height (similar to that shown for the height 310 and the recommended range 312 of seat positions) but is not shown here.

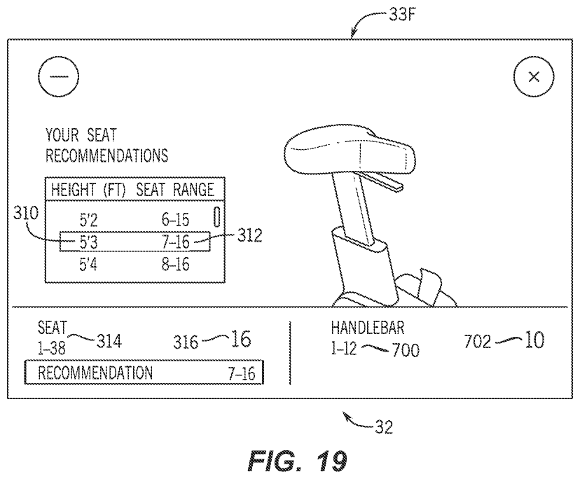

In contrast, FIG. 18 may represent a display 33E in which the user has logged, whereby previously stored positions for the seat and handlebar have been retrieved from memory. In this case, the previous seat position 704 and the previous handlebar position 706 are displayed for the user's convenience in adjusting the seat and/or handlebar to these or another desired position.

FIG. 19 shows a display 33F in which the seat is determined to have an actual position that is within a recommended range 710 for the user's entered or accessed height 310, in this case a seat position between 7 and 16. The display device 32 in this example is configured to cause the display 33F to indicate that the actual position of the seat matched (e.g., is within the recommended range and/or a threshold amount of a recommended seat position based on user height). In the example shown, this in indicated in the display 33F by displaying, highlighting, changing the color of, flashing, and/or making bold, the recommended range 710 when the actual position 316 is found to be a match. As stated above, a match may mean within the recommended range 710 or within a threshold amount thereof (e.g., within 1 position of the recommended range).

It should be recognized that displays similar to displays 33D-33F of FIGS. 17-19 may also be provided or other types of exercise machines, including recumbent bikes. In the case of recumbent bikes, a recline position may also be sensed and displayed in a similar manner as described above for the sliding seat and handlebar positions.

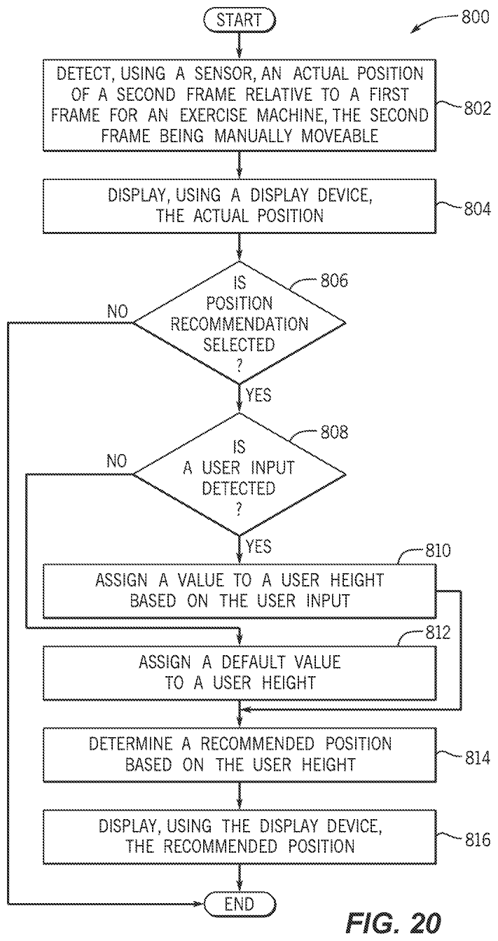

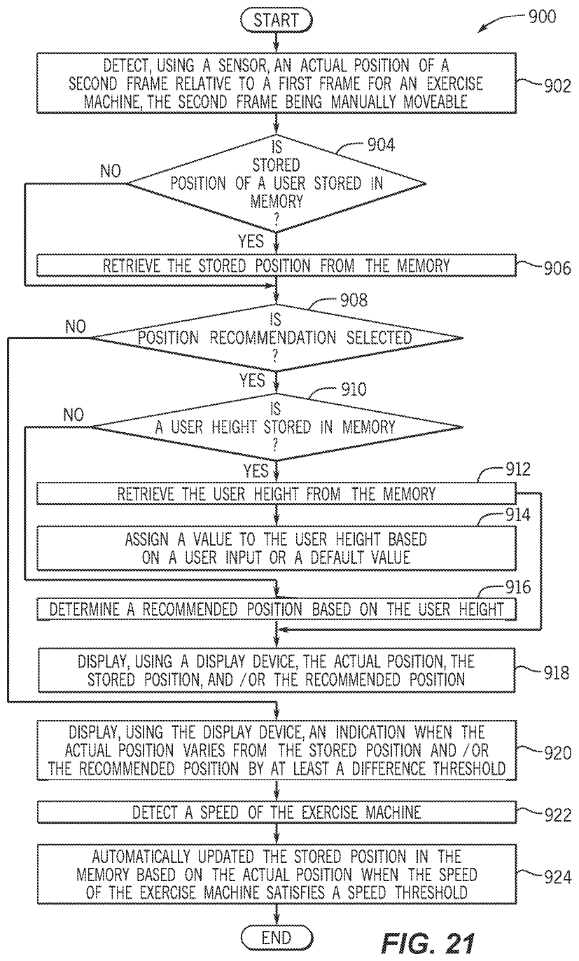

FIGS. 20 and 21 depict two further methods 800, 900 for controlling exercise machines according to the present disclosure, including causing display devices to produce the displays. The method 800 of FIG. 20 particularly relates to a configuration in which the system is able to provide one or more recommended positions for the exercise machine (e.g., the seat and/or handlebars) based on user height or a default height. Steps 802 and 804 may proceed in a similar manner as steps 502 and 504 described above for the method 500 shown in FIG. 15 and are thus not described further here. Step 806 provides for determining whether an optional feature of the system providing position recommendations has been selected, either to pop up on the display 32 when a user is detected to be present, or by the user selecting a position recommendation feature (e.g., accessed within a menu displayed by the display device 32). If not, the method concludes. If the system is configured to provide position recommendations, the method proceeds to step 808, which determines whether a user input is detected, and particularly relating to a height of the user.

If the user has provided height information in step 808, the process continues to step 810, assigning a value to the user input of step 808, such as the user's height in inches or centimeters, or a plus or minus deviation from an average user height. The process then proceeds to step 814, determining a recommended position for the seat and/or handlebars based on the value corresponding to the user's height from step 810. The recommended position or positions may be derived algorithmically, via modelling, or by accessing data (e.g., a lookup table) stored in memory based on user height for a particular exercise machine. The recommended positions may be singular values, or a range as shown in FIGS. 17-19. Step 816 may then proceed in a similar manner as step 506 described above, which assists the user in adjusting the positions until the actual positions match or are within the ranges of the recommended positions as determined in step 814. The process may then end as shown.

If instead no height information is provided in step 808, the process proceeds to step 812, which provides for assigning a default position value for the seat and/or handlebars. This may be determined in a similar manner as step 814 as described above, but for example using the average height or a female or male (which may depend upon whether the user has logged in and the exercise machine has such information). By way of example, step 814 may be determined for a female of 5′3″ or a male of 5′9″, in certain examples displaying the recommendations for both sexes such that the user has both pieces of information. The process then continues with steps 814 and 816 in the manner described above.

FIG. 21 shows a method 900 for controlling an exercise machine according to the present disclosure in which previously stored positions may be retrieved and/or current actual positions may be saved for future retrieval. Steps 902 and 910-920 may generally correspond to steps described above for FIG. 20. Therefore, for brevity, additional information relating to those steps may be referenced above. Step 904 determines whether a stored position for a position for the seat and/or handlebars has been stored in memory. If not, the process proceeds with step 908, which is discussed below. If a stored position is stored from memory in step 904, that stored position is retrieved from memory in step 906 and the process proceeds to step 908.

Step 908 may then be provided similarly to step 806 as described above, whereby if position recommendations are not selected then the process proceeds to step 918. If instead position recommendations are selected, step 910 provides for determining whether a user height is stored in memory. If so, that user height is retrieved from memory in step 912 and the process proceeds to step 916. If not, the process proceeds to step 914, which provides for assigning a value to the user height based on user inputs or a default value, which may be performed similarly to steps 808-812 as described above. A recommended position for the seat and/or handlebars is then provided determined in step 916, which may be performed similarly to step 814 described above.

The process then proceeds to step 918, which provides for displaying the actual position, the stored position, and/or the recommended position via the display device, and also providing an indication when the actual position varies from the stored position and/or the recommended position by at least a difference threshold 920, which was discussed further above. Step 922 then provides for further determining the speed of the exercise machine, which may be performed in a known manner, and then in step 924, automatically updating the stored position in memory based on the actual position when the speed of the exercise machine is determined in step 922. In the example shown, the method is then concluded, whereby this stored position is available for future reference.

In this manner, the presently disclosed exercise machines provide for assisting a user with setting up an exercise machine for performing an exercise motion, including moving seats and/or handlebars into desired locations. As described above, this assistance may be in addition to the presence of other demarcations or markings on the exercise machine corresponding to locations of seats, handlebars, and/or the like. Moreover, the present disclosure assists the user by retaining these desired locations for later reference and guidance to return to these desired locations. This may be particularly advantageous in the context of a gym in which many users use the same exercise machine, or for users that move the seat and/or handlebars to enter or exit the machine.

This written description uses examples to disclose the invention, including the best mode, and also to enable any person skilled in the art to make and use the invention. Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

What is claimed is:

1. An exercise machine configured for a user to perform an exercise motion, the exercise machine comprising:
a first frame configured to be positioned on a floor;
a second frame supported by the first frame, the second frame being manually moveable by the user relative to the first frame into a desired position for the user to perform the exercise motion;
a sensor that detects an actual position of the second frame relative to the first frame; and
a display device that displays the actual position detected by the sensor to assist the user in moving the second frame into the desired position.

2. The exercise machine according to claim 1, wherein the second frame supports a seat upon which the user sits to perform the exercise motion such that the seat is moveable relative to the first frame.

3. The exercise machine according to claim 1, wherein the second frame slides relative to the first frame.

4. The exercise machine according to claim 1, wherein the sensor comprises a circuit board and a magnet that is moveable relative to the circuit board, wherein the circuit board detects a position of the magnet relative thereto, wherein moving the second frame relative to the first frame changes the position of the magnet relative to the circuit board, and wherein the position of the second frame relative to the first frame is detected based on the position of the magnet relative to the circuit board.

5. The exercise machine according to claim 4, wherein the circuit board is stationary relative to the first frame, and wherein the magnet moves with the second frame.

6. The exercise machine according to claim 4, further comprising a casing that at least partially covers one of the first frame and the second frame, wherein the casing has an outer surface with a channel extending inwardly therefrom, and wherein the circuit board is positioned in the channel to be at least partially protected below the outer surface of the casing.

7. The exercise machine according to claim 6, further comprising a cover that encloses the circuit board within the channel to protect the circuit board therein.

8. The exercise machine according to claim 7, wherein the cover comprises markings for visually indicating the actual position of the second frame relative to the first frame separately from the sensor.

9. The exercise machine according to claim 1, further comprising a control system having a memory system for storing the actual position of the second frame detected by the sensor as a stored position, wherein the display device is configured to display the stored position to assist the user in moving the second frame into the desired position.

10. The exercise machine according to claim 9, further comprising a second sensor configured to detect a speed at which the exercise motion is performed, wherein the control system is configured to automatically store the actual position of the second frame as the stored position only when the speed of the exercise motion exceeds a minimum threshold.

11. The exercise machine according to claim 9, wherein the display device is configured to display an indication when the actual position detected by the sensor is different than the stored position.

12. The exercise machine according to claim 9, wherein the display device is configured to display the stored position and the actual position detected by the sensor at the same time to assist the user in moving the second frame into the stored position as the desired position.

13. The exercise machine according to claim 1, wherein the sensor is a first sensor, further comprising a third frame supported by the first frame, wherein the third frame is manually moveable by the user relative to the first frame into a desired position for the user to perform the exercise motion, and wherein the third frame is moveable independently from the second frame, further comprising a second sensor that detects an actual position of the third frame relative to the first frame, wherein the display device displays the actual position of the third frame detected by the second sensor to assist the user in moving the third frame into the desired position thereof.

14. The exercise machine according to claim 13, wherein the second frame supports handlebars configured to be gripped by the user and the third frame supports a seat configured for the user to sit thereon to perform the exercise motion.

15. The exercise machine according to claim 1, wherein the exercise motion is performed by the user pedaling.

16. A method for controlling an exercise machine, the exercise machine comprising a first frame configured to be positioned on a floor and a second frame supported by the first frame and manually moveable by a user relative to the first frame into a desired position for the user to perform an exercise motion, the method comprising detecting with a sensor an actual position of the second frame relative to the first frame and displaying with a display device the actual position detected by the sensor to assist the user in moving the second frame into the desired position.

17. The method according to claim 16, further comprising retrieving a stored position of the second frame relative to the first frame and displaying the stored position on the display device to assist the user in moving the second frame to the stored position as the desired position.

18. The method according to claim 16, further comprising retrieving a stored position of the second frame relative to the first frame, comparing the actual position detected by the sensor to the stored position, and indicating when the stored position and the actual position vary by at least a threshold difference.

19. The method according to claim 16, further comprising detecting a speed at which the exercise motion is performed, comparing the speed to a minimum threshold, and automatically storing the actual position of the second frame as a stored position when the speed of the exercise motion exceeds the minimum threshold.

20. The method according to claim 16, further comprising receiving height information for the user, determining a recommended position for the second frame relative to the first frame based on the height information, comparing the actual position detected by the sensor to the recommended position, and indicating when the recommended position and the actual position vary by at least a threshold difference.
